(19) United States
(12) Patent Application Publication
(10) Pub. No.: US 2012/0307235 A1
(43) Pub. Date: Dec. 6, 2012

(54) OPTICAL CABLE MEASUREMENT EQUIPMENT WITH FUNCTION OF OPERATING GUIDANCE

(76) Inventor: Ray-Jenn TSAY, Longtan Township (TW)

(21) Appl. No.: 13/153,829

(22) Filed: Jun. 6, 2011

(51) Int. Cl. G01N 21/00

(52) U.S. Cl. 356/73.1

(57) ABSTRACT

An optical cable measurement equipment with function of operating guidance includes a circuit board, a central processing unit (CPU), a measurement module, an output interface, an input interface and a power supply module. The CPU is arranged on and electrically connected with the circuit board. The measurement module is configured for implementing functions of optical cable measurement. The output interface is configured for outputting a prompting signal to guide a user to operate the optical cable measurement equipment. The input interface is configured for receiving operations of the user and generating a feedback signal. The CPU generates operating instruction according to the feedback signal. The power supply module is configured for providing required power of the optical cable measurement equipment. The above-mentioned optical cable measurement equipment is able to provide operating guidance by prompting signal of sound/voice, light, text or pattern to guide users to complete operating flow.

### BACKGROUND OF THE INVENTION

1. Field of the Invention

The present invention relates to an optical cable measurement equipment, and more particularly to an optical cable measurement equipment with function of operating guidance, by using voice, sound, light, text or pattern to guide users to complete operating flow for optical cable measurement.

2. Description of the Prior Art

Computer hardware and electronic industry are developed rapidly in recent years. Functionalities of electronic equipment are expanded along with faster speed of central processing unit disposed in the equipment. However, numerous functionalities have been followed by side effects, such as, complicated operation procedures, resulting in hindering operational efficiency. For example, an operation procedure of conventional optical cable measurement equipment is that operator manually inputs operational instructions according self-judgments of the operator to operational environment or operational steps, and then the optical cable measurement equipment responds according to the operational instructions passively. Therefore, the operator is not able to operate the optical cable measurement equipment efficiently and correctly if the operational environment is not well-arranged or the operator is not skillful. In the abovementioned circumstances, time must be wasted in halting or confirming operational status, resulting in affected operational flow or even improper wastage of the measurement equipment because of improper operation or misjudgment.

In summary, it is highly desirable to provide an optical cable measurement equipment being able to avoid improper operation or misjudgment and to improve measurement quality and efficiency.

### SUMMARY OF THE INVENTION

The present invention is directed to an optical cable measurement equipment with function of operating guidance, such as voice, sound, light, text or pattern to guide users to complete operating flow of optical cable measurement, thereby improving operational quality and efficiency.

According to an embodiment, an optical cable measurement equipment with function of operating guidance comprises at least one circuit board, at least one central processing unit, at least one measurement module, at least one output interface, at least one input interface and at least one power supply module. The central processing unit is arranged on and electrically connected with the circuit board. The measurement module is electrically connected with the central processing unit and configured for implementing optical cable measurement.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a schematic diagram illustrating the optical cable measurement equipment with function of operating guidance according to an embodiment of the present invention.

### DESCRIPTION OF THE PREFERRED EMBODIMENT

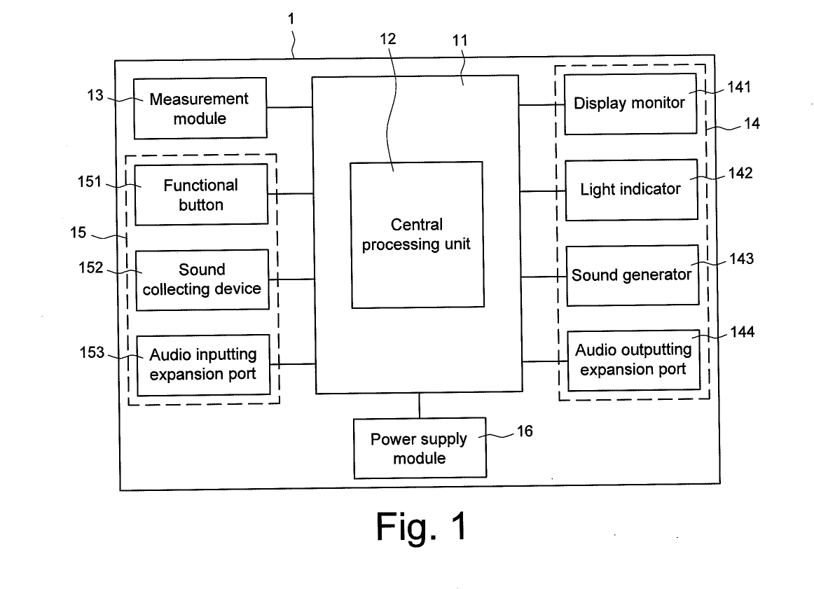

Referring to FIG. 1, an optical cable measurement equipment with function of operating guidance 1 according to one embodiment of the present invention includes at least one circuit board 11, at least one central processing unit 12, at least one measurement module 13, at least one output interface 14, at least one input interface 15 and at least one power supply module 16. The central processing unit 12 is arranged on and electrically connected with the circuit board 11. The measurement module 13 is electrically connected with the central processing unit 12 and configured for implementing of optical cable measurement. For example, the measurement module 13 may be an optical time domain reflectometer (OTDR), configured for measuring characteristics of optical cable, such as, length, signal attenuation, welding portion, adapting portion, landmark or breakpoint.

The output interface 14 is electrically connected with the central processing unit 12. The output interface 14 is configured for outputting a prompting signal to guide a user to operate the optical cable measurement equipment 1. The prompting signal may be text, pattern, light, sound or voice to guide the user to operate the optical cable measurement equipment 1. For example, the output interface 14 outputs the prompting signal including text, pattern or voice for the user to take proper response, when operating environment is not promising, such as poor illumination. For another example, when the user executes a specific operation and the output interface 14 then outputs a proper prompting signal to prompt the user to proceed another operation.

The input interface 15 is electrically connected with the central processing unit 11. The user may operate the optical cable measurement equipment 1 via the input interface 15. For example, when the user is prompted by the output interface 14, the user may input corresponding instructions via the input interface 15 and then the input interface 15 generates a feedback signal. The central processing unit 11 then outputs a corresponding operating instruction to control the optical cable measurement equipment 1 according to the feedback signal from the input interface 15. The power supply module 16 is configured for providing required power of the optical cable measurement equipment 1. For example, the power supply module 16 may be a primary battery or a rechargeable battery. In one embodiment of the present invention, the measurement module 13, the output interface 14, the input interface 15 and the power supply module 16 may be electrically connected with the circuit board 11 via a connector, a connecting cable or a plurality of connecting wires to be electrically connected with to central processing unit 12.

In one embodiment of the present invention, the output interface 14 may be a display monitor 141, a light indicator 142, a sound generator 143 or an audio outputting expansion port 144. For example, the display monitor 141 may be an alphanumeric type or an image type liquid crystal display monitor; the light indicator 142 may be a light emitting diode, a tungsten lamp or a neon lamp; the sound generator 143 may be a speaker, a single-frequency buzzer or a multi-frequency buzzer; the audio outputting expansion port 144 may be an earphone expansion socket or an audio output socket. The prompting signal in text or pattern formation may be outputted by the display monitor 141 to prompt and guide the user to operate the optical cable measurement equipment 1. The prompting signal in sound or voice format may be outputted by the sound generator 143 or the audio outputting expansion port 144 to prompt and guide the user to operate the optical cable measurement equipment 1.

In one embodiment of the present invention, the input interface 15 may be a functional button 151, a sound collecting device 152 or an audio inputting expansion port 153. For example, the functional button 151 may be a plastic button, a rubber button, a metal button or a touch panel button; the sound collecting device 152 may be a microphone or a voice sensor.

To sum up, the optical cable measurement equipment with function of operating guidance according to the present invention utilizes guiding information, such as voice, sound, light, text or pattern, for prompting the user with proper operating procedures or guiding the user to complete operating flow. Therefore, people who are not familiar with operating procedures may be able to complete operating flow according to the prompting signal of the optical cable measurement equipment of the present invention, thereby improving operational quality and efficiency.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An optical cable measurement equipment with function of operating guidance, comprising:
at least one circuit board;
at least one central processing unit, arranged on and electrically connected with said circuit board;
at least one measurement module, electrically connected with said central processing unit and configured for implementing optical cable measurement;
at least one output interface, electrically connected with said central processing unit and configured for outputting a prompting signal to guide a user to operate said optical cable measurement equipment;
at least one input interface, electrically connected with said central processing unit and configured for receiving operations from said user and generating a feedback signal, wherein said central processing unit generates operating instructions according to said feedback signal; and
at least one power supply module, configured for providing required power of said optical cable measurement equipment.

2. The optical cable measurement equipment with function of operating guidance according to claim 1, wherein said output interface comprises a display monitor, a light indicator, a sound generator or an audio outputting expansion port.

3. The optical cable measurement equipment with function of operating guidance according to claim 2, wherein said display monitor comprises an alphanumeric type or an image type liquid crystal display monitor.

4. The optical cable measurement equipment with function of operating guidance according to claim 2, wherein said light indicator comprises a light emitting diode, a tungsten lamp or a neon lamp.

5. The optical cable measurement equipment with function of operating guidance according to claim 2, wherein said sound generator comprises a speaker, a single-frequency buzzer or a multi-frequency buzzer.

6. The optical cable measurement equipment with function of operating guidance according to claim 2, wherein said audio outputting expansion port comprises an earphone expansion socket or and audio output socket.

7. The optical cable measurement equipment with function of operating guidance according to claim 1, wherein said input interface comprises a functional button, a sound collecting device or an audio inputting expansion port.

8. The optical cable measurement equipment with function of operating guidance according to claim 7, wherein said functional button comprises a plastic button, a rubber button, a metal button or a touch panel button.

9. The optical cable measurement equipment with function of operating guidance according to claim 7, wherein said sound collecting device comprises a microphone or a voice sensor.

10. The optical cable measurement equipment with function of operating guidance according to claim 1, wherein said prompting signal comprises text, pattern, light, sound or voice.

11. The optical cable measurement equipment with function of operating guidance according to claim 10, wherein said prompting signal including said text or said pattern is outputted by a display monitor to prompt said user to operate said optical cable measurement equipment.

12. The optical cable measurement equipment with function of operating guidance according to claim 10, wherein said prompting signal including said sound or said voice is outputted by a sound generator or an audio outputting expansion port.

13. The optical cable measurement equipment with function of operating guidance according to claim 1, wherein said measurement module, said output interface, said input interface and said power supply module are electrically connected with said circuit board via a connector, a connecting cable or a plurality of connecting wires.
